(19) United States
(12) Patent Application Publication
(10) Pub. No.: US 2024/0344661 A1
(43) Pub. Date: Oct. 17, 2024

(54) Reservoir comprising a pultruded cylindrical element

(71) Applicant: ARKEMA FRANCE, COLOMBES (FR)

(72) Inventors: Gilles HOCHSTETTER, Colombes Cedex (FR); Thibaut SAVART, Lacq (FR); Arthur BABEAU, Lacq (FR); Axel SALINIER, Lacq (FR)

(73) Assignee: ARKEMA FRANCE, COLOMBES (FR)

(21) Appl. No.: 18/292,690

(22) PCT Filed: Jul. 27, 2022
(86) PCT No.: PCT/FR2022/051514

§ 371 Date: Jan. 26, 2024

(30) Foreign Application Priority Data
Jul. 27, 2021 (FR) FR2108126

(51) Int. Cl. F17C 1/06; B29C 70/08; B29C 70/34; B29C 70/52; B29K 77/00; B29K 105/08; B29K 307/04; B29K 309/08; B29K 705/02; B29L 31/00

(52) U.S. Cl. CPC F17C 1/06; B29C 70/08; B29C 70/347; B29C 70/521; B29K 2077/10; B29K 2105/08; B29K 2307/04; B29K 2309/08; B29K 2705/02; B29L 2031/7156; F17C 2201/0104; F17C 2203/012; F17C 2203/0604; F17C 2203/0629; F17C 2203/067; F17C 2203/0673; F17C 2205/0311; F17C 2209/2154; F17C 2209/232; F17C 2221/011; F17C 2221/012; F17C 2221/014; F17C 2221/031; F17C 2221/033; F17C 2221/035; F17C 2223/0161

(57) ABSTRACT

A tank for containing a pressurized fluid, including at least one cylindrical element made of a pultruded fibrous material impregnated with a thermoplastic matrix, a first cap placed at one end of at least one cylindrical element closing it, a second cap placed at the other end of at least one cylindrical element, fitted with an orifice intended to make possible the entry and the exit of the fluid, and at least one additional fibrous reinforcement, partially or completely surrounding the cylindrical element(s) and optionally the caps, the fibers contained in the additional fibrous reinforcement being positioned along a different axis from the longitudinal axis of the cylindrical element, the total content of fibers of the tank being of between 40% and 70% by volume, with respect to the volume of the matrix and of the fibers contained in the tank.

The present invention relates to a tank intended to contain a pressurized fluid. The invention also relates to its process of manufacture, and also to its use for storing, transporting and/or dispensing fluids, in particular hydrogen.

At present, the ecological transition is tending to reduce oil consumption and to promote the use of less polluting types of energy. From this viewpoint, hydrogen is one of the fluids which are particularly studied. In particular, it is found that fuel cell vehicles are forming the subject of numerous research studies.

In this field, one of the difficulties with regard to the mass production of such vehicles is the design of the tanks. This is because the hydrogen tanks carried by these vehicles are subjected to operating pressures which can range up to 700 bars and must meet important safety requirements in order to limit as much as possible the consequences of a crash, of an accidental impact or of a fire. For example, when the tank is damaged during an accident in which the vehicle is involved or when a projectile fired by a firearm passes through the tank, it is desirable for the tank to release its pressure gradually, without exploding or bursting significantly. The same applies in the event of an increase in the temperature of the gas contained in the tank as a result of the vehicle catching fire.

An important advantage would be that they can easily be inserted into a car body, especially into the battery pack, replacing all or part of the batteries.

Another objective is to make it possible for such tanks to be obtained industrially for a reasonable cost, for example a cost acceptable for a motor vehicle application.

Furthermore, the pressure constraints required for a hydrogen tank mean that any other chemically non-aggressive fluid can be contained in such a tank from a mechanical viewpoint.

There is known, from the document FR 2 923 575, a tank for the storage of fluid under high pressure of cylindrical general shape and round section comprising, at each of its ends along its axis, a metal cap, a liner surrounding said caps and a structural layer made of fiber impregnated with thermosetting resin surrounding said liner.

There is also known, from the document WO2017/199193, a tank made of composite material comprising a tubular element, two caps respectively inserted into the ends of the tubular element, and a circumferential layer which surrounds the tubular element and the caps. The circumferential layer is formed of wound fibers impregnated with resin. The tubular element comprises a plastic tube surrounded by a longitudinal layer essentially consisting of fibers arranged in parallel in a resin matrix, the parallel fibers being oriented in the direction of the longitudinal axis of the plastic tube.

These “conventional” composite gas storage tanks generally exhibit an internal diameter in the cylindrical part of greater than or equal to 150 mm, for volumes typically of greater than 10 liters.

Conversely, “conformable” or else “polymorphic” gas storage tanks are generally composed of an assembly of closed tubes connected to one another. These polymorphic tanks are manufactured by assembling composite tubes having a small diameter, typically with an internal diameter of less than 150 mm.

However, the optimum technical solution for efficiently manufacturing this type of storage tank, in particular for storage under high pressure, for hydrogen, is not yet well defined.

The closure of the tubes by means of caps which can have the shape of hemispherical domes requires fibers positioned, ideally, in the axis of the tube in order to maintain these domes but, given the hemispherical shape of the domes, said fibers cannot be rigorously aligned in the axis of the tube, which is detrimental to their effectiveness and makes it necessary to use a greater amount of them than the strict minimum that can be envisaged, if they were indeed aligned in the axis of the tube.

Furthermore, when the diameter of the tube becomes too small, typically less than 150 mm, it becomes complicated to close the tube with domes exhibiting a radius of curvature which is large enough not to present a problem during the winding of the fibers around the tank.

Moreover, the production rates of these tubes are relatively slow, involving the production of a liner, then one or more specific windings of the fibers around this liner, and closure of the tube.

Finally, the most frequent composite tank solutions use a composite reinforcement based on thermosetting resin, in particular of the epoxy type. In point of fact, these composites are generally microcracked, making it essential to use a thick and heavy liner to ensure the leaktightness of the tank. The microcracking of thermosetting composites, in particular epoxy, is harmful to their mechanical strength and makes it necessary to increase the content of carbon fibers and thus the cost of the tank.

This disadvantage is combined with another, in the case where the composite reinforcements are manufactured by wet filament winding. This is because this type of process results in a high degree of porosity due to the absence of high pressure during the processing.

Finally, composite tanks based on thermosetting resin, in particular epoxy resin, cannot be recycled.

Thus, there is desired a tank which withstands high pressures, which is relatively easy and simple to produce and which can be recycled.

The invention is targeted at a tank for containing a pressurized fluid, comprising:
at least one cylindrical element made of a pultruded fibrous material impregnated with a thermoplastic matrix,
a first cap placed at one end of at least one cylindrical element closing it and
a second cap placed at the other end of at least one cylindrical element, fitted with an orifice intended to make possible the entry and the exit of the fluid, and
at least one additional fibrous reinforcement, partially or completely, preferably completely, surrounding the cylindrical element(s), and optionally the caps, the fibers contained in the additional fibrous reinforcement being positioned in a different axis from the longitudinal axis of the cylindrical element, the total content of fibers of the tank being of between 40% and 70% by volume, with respect to the volumes of the matrix and of the fibers contained in the tank.

The invention also relates to a process for the manufacture of the tank as defined above, characterized in that it comprises the following successive stages:
(a) pultrusion of the cylindrical element,
(b) placement of the caps at the ends of the cylindrical element obtained on conclusion of stage (a),
(c) deposition of the additional fibrous reinforcement.

Finally, the invention relates to the use of the tank as defined above for the storage, the transportation and/or the distribution of fluids, such as gases, in the compressed form, in the liquid form or also in the cryocompressed form, and in particular of hydrogen, natural gas, LPG, LNG, compressed air, nitrogen or oxygen.

### BRIEF DESCRIPTION OF THE FIGURE

FIG. 1 is a diagram illustrating the process of preparation of a cylindrical element made of a pultruded fibrous material impregnated with a thermoplastic matrix with an additional fibrous reinforcement for the tank according to the invention.

FIG. 2 is a diagram illustrating another process for the preparation of a cylindrical element made of a pultruded fibrous material impregnated with a thermoplastic matrix with an additional fibrous reinforcement for the tank according to the invention.

### DETAILED DESCRIPTION OF THE INVENTION

Other characteristics, aspects, subject matters and advantages of the present invention will become even more clearly apparent on reading the description which follows.

It is specified that the expressions “from . . . to . . . ” and “of between . . . and . . . ” used in the present description should be understood as including each of the limits mentioned.

### Tank

The tank according to the invention comprises:
at least one cylindrical element made of a pultruded fibrous material impregnated with a thermoplastic matrix,
a first cap placed at one end of at least one cylindrical element closing it and
a second cap placed at the other end of at least one cylindrical element, fitted with an orifice intended to make possible the entry and the exit of the fluid, and
at least one additional fibrous reinforcement, partially or completely, preferably completely, surrounding the cylindrical element(s), and optionally the caps, the fibers contained in the additional fibrous reinforcement being positioned along a different axis from the longitudinal axis of the cylindrical element, the total content of fibers of the tank being of between 40% and 70% by volume, with respect to the volumes of the matrix and of the fibers contained in the tank.

The cylindrical element is manufactured according to a pultrusion process. It thus consists of fibers impregnated with a thermoplastic matrix. Pultrusion is a generally continuous process, which applies a traction of the fibers through a die in the axis of the cylindrical element, the fibers not necessarily being oriented in the axis of the traction. Pultrusion covers the impregnation of dry fibers, for example braids of dry fibers, fabrics of dry fibers or unidirectional rovings. It also covers processing in the form of profiled elements of fibers which are coblended, of fibers which are preimpregnated, of braids which are preimpregnated with resin. According to the latter case, the fibers can be preimpregnated before the pultrusion stage.

Generally, the tubes of the prior art consist of a tube, called a “liner”, which is subsequently covered with fibers. In point of fact, the tank according to the invention comprises a cylindrical element, which already comprises fibers. This aspect of the tank according to the invention is highly advantageous. This is because the manufacture of cylindrical elements by pultrusion is productive, even for thick elements, because the entire volume of the cylindrical element is produced continuously and in a single stage. Moreover, the incorporation of the fibers in the cylindrical element makes it possible to dispense with the deposition of an impregnated fibrous reinforcement in the axis of the tube. This is because this deposition stage is relatively slow and not always easy to control.

According to one embodiment of the invention, in particular according to the type of fluid targeted, the tank according to the invention may contain a liner. However, this liner is not essential.

### The Fibers

Concerning the constituent fibers of said fibrous material, these are in particular fibers of inorganic, organic or vegetable origin in the form of rovings.

Advantageously, the number of fibers per roving is, for carbon fibers, greater than or equal to 12K, greater than 24K, in particular greater than or equal to 50K, especially of from 24K to 36K.

Advantageously, the basis weight for the glass fiber is, for each roving, greater than or equal to 1200 tex, in particular less than or equal to 4800 tex, especially of from 1200 to 2400 tex.

Mention may be made, among the fibers of inorganic origin, of carbon fibers, glass fibers, basalt or basalt-based fibers, silica fibers or silicon carbide fibers, for example. Mention may be made, among the fibers of organic origin, of fibers based on thermoplastic or thermosetting polymer, such as semiaromatic polyamide fibers, aramid fibers or polyolefin fibers, for example. Preferably, they are based on amorphous thermoplastic polymer and exhibit a glass transition temperature Tg which is greater than the Tg of the constituent thermoplastic polymer or polymer blend of the impregnation matrix when the polymer or polymer blend is amorphous or greater than the M.p. of the constituent thermoplastic polymer or polymer blend of the impregnation matrix when the polymer or polymer blend is semicrystalline. Advantageously, they are based on semicrystalline thermoplastic polymer and exhibit a melting point M.p. which is greater than the Tg of the constituent thermoplastic polymer or polymer blend of the impregnation matrix when the polymer or polymer blend is amorphous or greater than the M.p. of the constituent thermoplastic polymer or polymer blend of the impregnation matrix when the polymer or polymer blend is semicrystalline. Thus, there is no risk of melting for the constituent organic fibers of the fibrous material during the impregnation by the thermoplastic matrix of the final composite. Mention may be made, among the fibers of vegetable origin, of natural fibers based on flax, hemp, lignin, bamboo, silk, in particular spider silk, sisal, and other cellulose fibers, in particular viscose fibers. These fibers of vegetable origin can be used pure, treated or else coated with a coating layer, for the purpose of facilitating the adhesion and the impregnation of the thermoplastic polymer matrix.

It can also correspond to fibers with support yarns.

These constituent fibers can be used alone or as mixtures. Thus, organic fibers can be mixed with inorganic fibers in order to be impregnated with thermoplastic polymer and to form the impregnated fibrous material.

The rovings of organic fibers can have several basis weights. In addition, they can exhibit several geometries.

The fibers are provided in the form of continuous fibers, which make up 2D fabrics, nonwovens (NCFs), braids or rovings of unidirectional (UD) fibers or nonwovens. The constituent fibers of the fibrous material can additionally be in the form of a mixture of these reinforcing fibers of various geometries. Preferably, the fibers included in the pultruded fibrous material of the cylindrical element are a braid of dry fibers.

Preferably, the fibrous material is chosen from glass fibers, carbon fibers, basalt fibers and basalt-based fibers. According to a first advantageous embodiment, the fibrous material is chosen from glass fibers. According to a second advantageous embodiment, the fibrous material is chosen from carbon fibers. According to a third advantageous embodiment, the fibrous material is chosen from basalt-based fibers.

Advantageously, the fibers are used in the form of a roving or of several rovings.

### The Thermoplastic Matrix

The term “thermoplastic” or “thermoplastic polymer” is understood to mean a material which is generally solid at ambient temperature, which can be semicrystalline or amorphous, and which softens during an increase in temperature, in particular after passing through its glass transition temperature (Tg), and flows at a higher temperature when it is amorphous, or which can exhibit obvious melting on passing through its “melting” point (M.p.) when it is semicrystalline, and which becomes solid again during a reduction in temperature below its crystallization point (for a semicrystalline polymer) and below its glass transition temperature (for an amorphous polymer).

The glass transition temperature, denoted Tg below, and the melting point, denoted M.p. below, are determined by differential scanning calorimetry (DSC) according to the standard ISO 11357-2:2013 and 11357-3:2013 respectively.

The thermoplastic polymer can be an amorphous polymer exhibiting a glass transition temperature Tg of greater than or equal to 50° C., in particular of greater than or equal to 100° C., especially of greater than or equal to 120° C., in particular of greater than or equal to 140° C., or a semicrystalline thermoplastic polymer, the melting point M.p. of which is greater than 150° C.

The matrix is described as “thermoplastic”, which means that the predominant component of the matrix is a thermoplastic polymer or else a blend of thermoplastic polymers. Advantageously, said at least thermoplastic polymer is selected from: poly(aryl ether ketone) s (PAEKs), in particular poly(ether ether ketone) (PEEK); poly(aryl ether ketone ketone) s (PAEKKs), in particular poly(ether ketone ketone) (PEKK); aromatic polyetherimides (PEIs); polyaryl sulfones, in particular polyphenylene sulfones (PPSUs); polyaryl sulfides, in particular polyphenylene sulfides (PPSs); polyamides (PAS), in particular semiaromatic polyamides (polyphthalamides) optionally modified by urea units; PEBAs, the M.p. of which is greater than 150° C.; polyacrylates, in particular polymethyl methacrylate (PMMA); polyolefins, with the exclusion of polypropylene; polylactic acid (PLA); polyvinyl alcohol (PVA); fluoropolymers, in particular polyvinylidene fluoride (PVDF) or polytetrafluoroethylene (PTFE) or polychlorotrifluoroethylene (PCTFE); polyvinyl chloride (PVC) and acrylonitrile-butadiene-styrene (ABS) polymer and their blends, in particular a blend of PEKK and of PEI, preferably from 90-10% by weight to 60-40% by weight, in particular from 90-10% by weight to 70-30% by weight.

Advantageously, said at least thermoplastic polymer is selected from polyamides, aliphatic polyamides, cycloaliphatic polyamides and semiaromatic polyamides (polyphthalamides), PEKK, PEI and a blend of PEKK and of PEI.

The nomenclature used to define the polyamides is described in the standard NF EN ISO 1874-1:2011, “Plastics-Polyamide (PA) Moulding and Extrusion Materials-Part 1: Designation”, in particular on page 3 (Tables 1 and 2), and is well known to a person skilled in the art.

The polyamide can be a homopolyamide or a copolyamide or a blend of these.

For tanks which have to withstand high temperatures, use is advantageously made according to the invention of poly(aryl ether ketone) s PAEKs, such as poly(ether ketone) s PEKs, poly(ether ether ketone) PEEK, poly(ether ketone ketone) PEKK, poly(ether ketone ether ketone ketone) (PEKEKK) or PAs having a high glass transition temperature Tg.

Advantageously, said polyamide is chosen from aliphatic polyamides, cycloaliphatic polyamides and semiaromatic polyamides (polyphthalamides).

Advantageously, the aliphatic polyamide is chosen from polyamide 6 (PA6), polyamide 11 (PA11), polyamide 12 (PA12), polyamide 66 (PA66), polyamide 46 (PA46), polyamide 610 (PA610), polyamide 612 (PA612), polyamide 1010 (PA1010), polyamide 1012 (PA1012), polyamide 11/1010 (PA11/1010) and polyamide 12/1010 (PA12/1010), or a blend of these or a copolyamide of these, and block copolymers, in particular polyamide/polyether (PEBA) copolymers, and the semiaromatic polyamide is a semiaromatic polyamide optionally modified by urea units, in particular a PA MXD6 and a PA MXD10, or a semiaromatic polyamide of formula X/YAr, as described in EP 1 505 099, in particular a semiaromatic polyamide of formula A/XT in which:
A is chosen from a unit obtained from an amino acid, a unit obtained from a lactam and a unit corresponding to the formula (Ca diamine). (Cb diacid), with a representing the number of carbon atoms of the diamine and b representing the number of carbon atoms of the diacid, a and b each being of between 4 and 36, advantageously between 9 and 18, the (Ca diamine) unit being chosen from linear or branched aliphatic diamines, cycloaliphatic diamines and alkylaromatic diamines and the (Cb diacid) unit being chosen from linear or branched aliphatic diacids, cycloaliphatic diacids and aromatic diacids;
XT denotes a unit obtained from the polycondensation of a Cx diamine and of terephthalic acid (T), with x representing the number of carbon atoms of the Cx diamine, x being of between 6 and 36, advantageously between 9 and 18. Advantageously, a semiaromatic polyamide is of formula A/6T, A/9T, A/10T or A/11T, A being as defined above, in particular a polyamide PA 6/6T, a PA 66/6T, a PA 61/6T, a PA MPMDT/6T, a PA 11/10T, a PA 11/6T/10T, a PA MXDT/10T, a PA MPMDT/10T, a PA BACT/10T, a PA BACT/6T, a PA BACT/10T/6T or a PA 11/BACT/10T; T corresponds to terephthalic acid, MXD corresponds to m-xylylenediamine, MPMD corresponds to methylpentamethylenediamine and BAC corresponds to bis(aminomethyl) cyclohexane.

Advantageously, said thermoplastic polymer is a semicrystalline polymer.

Advantageously, said semicrystalline polymer exhibits a glass transition temperature such that Tg≥80° C., in particular Tg≥100° C., especially≥120° C., in particular ≥140° C., and an M.p.≥150° C.

In the latter case, said at least semicrystalline thermoplastic polymer is selected from: poly(aryl ether ketone) s (PAEKs), in particular poly(ether ether ketone) (PEEK); poly(aryl ether ketone ketone) s (PAEKKs), in particular poly(ether ketone ketone) (PEKK); aromatic polyetherimides (PEIs); polyaryl sulfones, in particular polyphenylene sulfones (PPSUs); polyaryl sulfides, in particular polyphenylene sulfides (PPSs); polyamides (PAS), in particular semiaromatic polyamides (polyphthalamides) optionally modified by urea units; polyacrylates, in particular polymethyl methacrylate (PMMA); polyolefins, with the exclusion of polypropylene; polylactic acid (PLA); polyvinyl alcohol (PVA); polyvinyl chloride (PVC) and acrylonitrile-butadiene-styrene (ABS) polymer; and their blends, in particular a blend of PEKK and of PEI, preferably from 90-10% by weight to 60-40% by weight, in particular from 90-10% by weight to 70-30% by weight.

More advantageously, in the latter case, said at least thermoplastic polymer is selected from polyamides, aliphatic polyamides, cycloaliphatic polyamides and semiaromatic polyamides (polyphthalamides), PEKK, PEI and a blend of PEKK and of PEI.

### The Impregnated Pultruded Fibrous Material

In the impregnated materials, also referred to as “ready for use” materials, the impregnating thermoplastic polymer or blend of thermoplastic polymers is distributed uniformly and homogeneously around the fibers. In this type of material, the impregnating thermoplastic polymer must be distributed as homogeneously as possible within the fibers in order to obtain a minimum of porosities, that is to say a minimum of voids between the fibers. Specifically, the presence of porosities in materials of this type can act as points of concentrations of stresses, for example during placing under mechanical tensile stress, and which then form points of initiation of failure of the impregnated fibrous material and mechanically weaken it. A homogeneous distribution of the polymer or blend of polymers thus improves the mechanical strength and the homogeneity of the composite material formed from these impregnated fibrous materials.

Advantageously, the content of fibers in said pultruded impregnated fibrous material is of from 45% to 70% by volume, preferably from 50% to 70% by volume, preferably from 50% to 60% by volume, in particular from 54% to 60% by volume, with respect to the volume of the pultruded impregnated fibrous material.

The measurement of the content of fibers in general can be carried out by image analysis (use of microscope or of camera or of digital camera, in particular) of a cross section of the cylindrical element, by dividing the surface area of the fibers by the surface area of the cylindrical element (impregnated surface area plus surface area of the porosities). In order to obtain a good quality image, it is preferable to coat the cylindrical element, cut across its transverse direction, in a standard polishing resin and to polish with a standard protocol making possible the observation of the sample with a microscope at at least six times magnification. The image size to be analyzed is between 10-12 times the diameter of the fiber. Between 5 and 40 images at different locations (sections) are taken. The mean is taken over all the images and recalculated by volume.

For the measurement of the content of fibers in the part of the additional fibrous reinforcement, if this is a fibrous material based on continuous fibers impregnated with a thermoplastic matrix, the same measurement is made but on a section perpendicular to the direction of the fibers of the additional fibrous reinforcement.

If the fibers are carbon fibers, the measurement of the content of carbon fibers can be determined according to ISO 14127:2008.

If the fibers are glass fibers, the measurement of the content of fibers is determined according to ISO 1172:1999.

Advantageously, the degree of porosity of said impregnated fibrous material is less than 10%, in particular less than 5%, especially less than 2%.

It should be noted that a degree of porosity of zero is difficult to achieve and that consequently, advantageously, the degree of porosity is greater than 0% but less than the abovementioned degrees.

The degree of porosity corresponds to the degree of closed porosity and can be determined either by electron microscopy, or as being the relative deviation between the theoretical density and the experimental density of said impregnated fibrous material as described in the examples part of EP 3 418 323.

The composite material is leaktight, inert and resistant to the internal pressure of the pressurized fluid.

Preferably, the tank according to the invention comprises fibrous materials comprising, as fibers, fibers chosen from glass fibers, carbon fibers, basalt fibers and basalt-based fibers and, as thermoplastic matrix, polymers chosen from polyamides, aliphatic polyamides, cycloaliphatic polyamides, semiaromatic polyamides (polyphthalamides), PEKKs, PEIs and a blend of PEKK and of PEI.

The impregnated fibrous material is thus manufactured by pultrusion in the form of a cylinder.

According to one embodiment, the internal diameter of the cylindrical element can be of between 50 and 150 mm. This diameter size is targeted in particular at tanks for battery packs, for example for cars or trailer chassis.

According to another embodiment, the internal diameter of the cylindrical element can be greater than 150 mm. This diameter size is targeted in particular at hydrogen transportation trailer tanks.

The length of the cylindrical element can be of between 25 cm and 10 m, preferably between 50 cm and 3 m. A person skilled in the art will know how to adapt the dimensions of the cylindrical element according to the intended purpose of the tank.

According to another embodiment, the ratio of the thickness of the wall of the tank to its internal diameter can be of between 0.05 and 0.20, preferably between 0.08 and 0.12.

### The Caps

The tank according to the invention comprises two caps at its ends. These caps are generally made of metal, preferably made of an aluminum alloy.

The first cap is placed at one end of at least one cylindrical element closing it. It thus constitutes the bottom of the tank.

The second cap is placed at the other end of at least one cylindrical element, fitted with an orifice intended to make possible the entry and the exit of the fluid. It can be a valve.

According to one embodiment of the tank according to the invention, the first cap placed at one end of at least one cylindrical element closing it can also be fitted with an orifice intended to make possible the entry and the exit of the fluid.

The caps can have a hemispherical dome shape or else a cone shape.

Elastomeric seals can be placed between the caps and the cylindrical element in order to ensure the leaktightness of the tank.

### Additional Fibrous Reinforcement

The tank according to the invention also comprises at least one additional fibrous reinforcement, partially or completely, in particular completely, surrounding the cylindrical element(s) and optionally the caps.

Within the meaning of the present invention, the term “fibrous reinforcement” is understood to mean a material comprising fibers which confers a greater mechanical strength on the final part.

The additional fibrous reinforcement is chosen from dry continuous fibers, a fibrous material based on continuous fibers impregnated with a thermoplastic matrix, and their mixture.

When the additional fibrous reinforcement is dry fibers, the latter can be chosen from those defined above.

When the additional fibrous reinforcement is a fibrous material based on continuous fibers impregnated with a thermoplastic matrix, it can be identical to or different from the fibrous material constituting the cylindrical element.

When the additional fibrous reinforcement is a fibrous material based on continuous fibers impregnated with a thermoplastic matrix, the total content of fibers of the tank, which is of between 40% and 70% by volume, with respect to the volumes of the matrix and of the fibers contained in the tank, takes into account the matrix of the pultruded thermoplastic-impregnated fibrous material and the matrix of the additional fibrous reinforcement. In other words, the total content of fibers of the tank is of between 40% and 70% by volume, with respect to the volumes of the matrices and fibers contained in the tank.

According to one embodiment, the additional fibrous reinforcement is chosen from a braid of dry fibers, a braid of fibrous tapes impregnated with thermoplastic resin, and their mixture.

Thus, according to a first embodiment, the fibers included in the fibrous material can be a braid of dry fibers and the additional fibrous reinforcement can also be a braid of dry fibers.

According to a second embodiment, the fibers included in the fibrous material can be rovings of continuous fibers and the additional fibrous reinforcement can also be a braid of dry fibers.

According to a third embodiment, the fibers included in the fibrous material can be a braid of fibers and the additional fibrous reinforcement can also be rovings of dry continuous fibers.

According to a fourth embodiment, the fibers included in the fibrous material can be a braid of fibers and the additional fibrous reinforcement can also be rovings of continuous fibers which are impregnated.

According to a fifth embodiment, the fibers included in the fibrous material can be rovings of continuous fibers and the additional fibrous reinforcement can also be rovings of continuous fibers which are impregnated.

The thermoplastic matrix of the additional fibrous reinforcement can be identical to or different from that of the cylindrical element. Preferably, the thermoplastic matrix of the cylindrical element is completely or partially miscible with the thermoplastic matrix of the additional fibrous reinforcement. This complete or partial miscibility makes it possible to increase the adhesion between the wall of the cylindrical element and the layer of the additional fibrous reinforcement.

According to a particular embodiment of the invention, the tank can comprise a cylindrical element, the thermoplastic matrix of which is made of PVC, and a fibrous reinforcement, the polymeric matrix of which is made of acrylic.

According to another particular embodiment of the invention, the tank can comprise a cylindrical element, the thermoplastic matrix of which is made of ABS, and a fibrous reinforcement, the polymeric matrix of which is made of acrylic.

According to yet another particular embodiment of the invention, the tank can comprise a cylindrical element, the thermoplastic matrix of which is made of polyamide, and a fibrous reinforcement, the polymeric matrix of which is made of polyphthalamide.

Preferably, the thermoplastic matrix of the additional fibrous reinforcement exhibits a melting point of greater than 150° C.

Preferably, the thermoplastic matrix of the additional fibrous reinforcement exhibits a glass transition temperature of greater than 80° C., preferably of greater than 100° C. and more particularly of greater than 120° C.

More particularly, the thermoplastic matrix of the additional fibrous reinforcement exhibits a melting point of greater than 150° C. and glass transition temperature of greater than 80° C., preferably of greater than 100° C. and more particularly of greater than 120° C.

The thickness of the layer of the fibrous reinforcement can be of between 0.5 mm and 10 mm, preferably between 0.5 mm and 5 mm.

The total content of fibers is of between 40% and 70% by volume, with respect to the sum of the volume of the matrix and of the fibers, preferably between 50% and 70% by volume.

Within the meaning of the present invention, the term “the total content of fibers” is understood to mean the sum of the content of fibers contained in the tank, that is to say in the cylindrical element and in the additional fibrous reinforcement.

The additional fibrous reinforcement comprises fibers positioned along an axis different from the longitudinal axis of the cylindrical element, preferably at an angle of between +/−10° and +/−89° with respect to the longitudinal axis of the cylindrical element, preferably, an angle of between +/−25° and +/−89° from the axis of the cylindrical element, more preferentially between +/−45° and +/−89°.

In other words, the longitudinal axis of the cylindrical element constitutes the 0° axis, and the direction of the fibers of the additional reinforcement constitutes a second axis. The angle between these two axes is as defined above. The +/− signs indicate whether the fibers of the additional fibrous reinforcement are positioned to the right or else to the left depending on the axis of the cylindrical element.

It has been observed that the deposition of a fibrous reinforcement in a different axis makes it possible to increase the resistance to internal pressure of the wall of the tank.

Preferably, a portion of the fibers included in the material of the cylindrical element is positioned in the longitudinal axis of the cylindrical element. More particularly, all of the fibers included in the material of the cylindrical element are positioned along the axis of the cylindrical element.

According to one embodiment, the tank can comprise a second cylindrical element composed of one or more layers of thermoplastic resin, not comprising fibers, also referred to as liner. This second cylindrical element can make it possible to increase the leaktightness of the tank. It can also make it possible to increase the resistance to pressure of the tank, indeed even to reinforce the chemical resistance of the final part.

In other words, the tank according to the invention can comprise a liner, then, above, a cylindrical element as defined above, then an additional fibrous reinforcement as defined above. The length and the diameter of the tank can be greater or smaller. These dimensions vary according to the fluid to be stored and the structure which will receive the tank.

Preferably, the tank according to the invention comprises:
one or more cylindrical elements, the fibers of which are positioned in the axis of the cylindrical element, and
one or more additional fibrous reinforcements, the fibers of which are positioned in an axis different from the axis of the cylindrical element, the caps are fixed to the ends of the cylindrical element(s) by crimping. According to this embodiment, the caps are not of hemispherical shape.

Within the meaning of the present invention, the term “crimping” is understood to mean that the additional fibrous reinforcement is crushed or flattened over the caps.

Preferably, the additional fibrous reinforcement is a layer partially or completely, preferably completely, surrounding the cylindrical element, which has been flattened beforehand over the caps, the layer being made of a fibrous material impregnated with thermoplastic resin.

According to a particularly preferred embodiment, the tank according to the invention comprises:
one or more cylindrical elements, the fibers of which are positioned in the axis of the cylindrical element, and
an additional fibrous reinforcement, the fibers of which are positioned between +/−45° and +/−89° with respect to the axis of the cylindrical element.

According to another embodiment, the tank according to the invention comprises:
one or more cylindrical elements, the fibers of which included in the fibrous material are a braid,
one or more additional fibrous reinforcements, the fibers of which are a braid of dry or impregnated fibers positioned along an axis different from the axis of the braid of the cylindrical element.

According to one embodiment, the tank according to the invention can comprise several cylindrical elements connected together and exhibiting an internal diameter of less than 250 mm, preferably of less than 150 mm. According to this embodiment, the tank comprises:
first cap placed at one end of at least one cylindrical element closing it, then
a cylindrical element made of a pultruded fibrous material impregnated with a thermoplastic matrix, then
a connecting piece making possible both the entry and the exit of the fluid and the connection with the adjacent cylindrical element, then
a cylindrical element made of a pultruded fibrous material impregnated with a thermoplastic matrix;
this sequence: cylindrical element-connecting piece can be repeated several times as required; then
a final cap placed at the other end of at least one cylindrical element, fitted with an orifice intended to make possible the entry and exit of the fluid from the whole of the tank.

The invention also relates to the process for the manufacture of the tank according to the invention. The process comprises the following successive stages:
(a) pultrusion of the cylindrical element,
(b) placement of the caps at the ends of the cylindrical element obtained on conclusion of stage (a),
(c) deposition of the additional fibrous reinforcement.

According to one embodiment, the stage of deposition of the additional fibrous reinforcement can be carried out by winding the tape of additional fibrous reinforcement around the cylindrical element and its caps. This deposition can be carried out under a certain mechanical stress so as to exert pressure on the caps and the cylindrical element.

According to another embodiment, the caps exhibit an external diameter which is smaller than the internal diameter of the cylindrical element. The caps can thus be inserted into the cylindrical element. In this case, the fibrous reinforcement winds the cylindrical element only. This is because the latter already surrounds the caps.

Finally, the invention relates to the use of the tank according to the invention for the storage, the transportation and/or the distribution of fluids, such as gases, in the compressed form, in the liquid form or also in the cryocompressed form, and in particular of hydrogen, natural gas, LPG, LNG, compressed air, nitrogen or oxygen.

### DESCRIPTION OF THE FIGURE

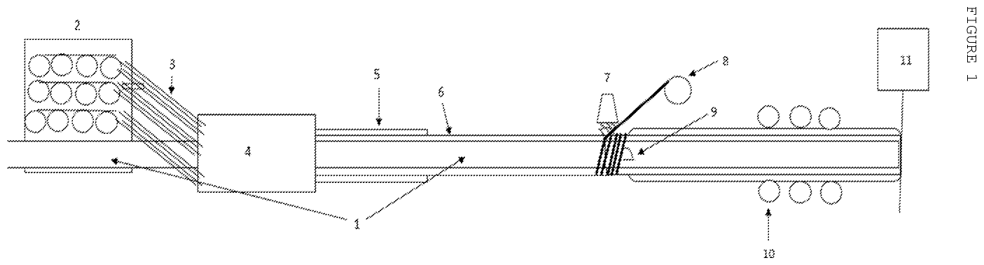

The process according to the invention can be illustrated by FIG. 1.

FIG. 1 illustrates a pultrusion process. The element 1 is an extruded tube (as cylindrical element), which will make it possible to give the shape to the final pultruded element. The dry fibers 3 leave the reels supported by the creel 2 and pass into the impregnation zone 4. This zone 4 comprises a bath of liquid resin or else a head for injection of the resin. The pultrusion die 5 guides the pultruded impregnated fibers resulting in the pultruded layer 6. The pultruded impregnated fibers undergo heating generated by a heating element 7. A reel 8 supports the additional fibrous reinforcement, which will be wound around the pultruded tube, according to an angle 9. The entire pultruded tube is pulled by pullers 10. The pultruded tube is subsequently cut by a cutting appliance 11.

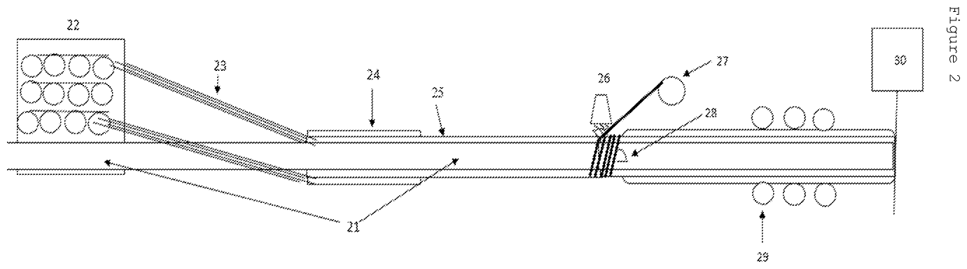

FIG. 2 illustrates another pultrusion process. The element 21 is an extruded tube, which will make it possible to give the shape to the final pultruded element. The fibers impregnated with resin 23 leave the reels supported by the creel 22 and pass into the pultrusion die 24. The latter guides the impregnated fibers and conforms them, resulting in the pultruded layer 25. The pultruded impregnated fibers undergo heating generated by a heating element 26. A reel 27 supports the additional fibrous reinforcement, which will be wound around the pultruded tube, according to an angle 28. The entire pultruded tube is pulled by pullers 29. The pultruded tube is subsequently cut by a cutting appliance 30.

### EXAMPLES

### Example 1

A composite tube, of circular section, exhibiting an external diameter of 170 mm and a thickness of 2 mm, is manufactured by pultrusion, at a rate of 0.5 m/min, by means of a melt impregnation process, using a tubular die connected to a single-screw extruder. The resin used for the pultrusion is a grade of polyamide 11 of low viscosity (reference Rilsan® FMNO) making it possible to obtain good impregnation of the fibers. This polyamide 11 resin exhibited an M.p. of 190° C. (measured according to the standard ISO 11357-3:2013) and the temperature in the pultrusion die was 250° C. The fibers used were 50K carbon fibers sold by SGL, of reference Sigrafil C-T 50 4.8/280 T140. The fiber content was 45 vol % (fiber content with respect to the volume of the pultruded tube). The orientation of the fibers in the pultrusion die was exclusively along the axis of the tube.

The tube was cut to a length of 1.5 m. Two caps, 20 mm in length, were placed at each of the 2 ends of the tube. A leaktightness seal of Rubson® brand was placed at the interface between the caps and the tubes. These caps consisted of an aluminum cylinder with a diameter of 80 mm, drilled with an M25 threaded hole, making possible linking with the standard connectors used in hydrogen.

An additional reinforcement consisting of Hyosung H2550 G10 carbon fibers not impregnated with resin (i.e., dry fibers reinforcement) was wound helically around the pultruded tube so as to take up the forces imposed by the pressure internal to the tube on the caps, over a thickness of 4 mm. Subsequently, the fibrous reinforcement consisting of dry fibers was wound at 85° from the axis of the tube, over a thickness of 4 mm. The tube was closed with an M25 threaded plug at one of these ends and then pressurized at ambient temperature up to bursting. The bursting pressure measured was 1600 bar.

### Example 2

A composite tube, of circular section, exhibiting an external diameter of 170 mm and a thickness of 2 mm, is manufactured by pultrusion, at a rate of 0.5 m/min, by means of a melt impregnation process, using a tubular die connected to a single-screw extruder. The resin used for the pultrusion is a grade of polyamide 11 of low viscosity (reference Rilsan® FMNO) making it possible to obtain good impregnation of the fibers. This polyamide 11 resin exhibited an M.p. of 190° C. (measured according to the standard ISO 11357-3:2013) and the temperature in the pultrusion die was 250° C. The fibers used were 50K carbon fibers sold by SGL, of reference Sigrafil C-T 50 4.8/280 T140. The fiber content was 45 vol % (fiber content with respect to the volume of the pultruded tube). The orientation of the fibers in the pultrusion die was exclusively along the axis of the tube.

The tube was cut to a length of 1.5 m. Two caps, 20 mm in length, were placed at each of the 2 ends of the tube. A leaktightness seal of Rubson® brand was placed at the interface between the caps and the tubes. These caps consisted of an aluminum cylinder with a diameter of 80 mm, drilled with an M25 threaded hole, making possible linking with the standard connectors used in hydrogen.

An additional fibrous reinforcement, consisting of a composite tape with a width of ½″, was wound helically around the pultruded tube so as to take up the forces imposed by the pressure internal to the tube on the caps, over a thickness of 4 mm. Subsequently, the composite tape was wound, perpendicular to the axis of the tube (given the width of the tape and the diameter of the pultruded tube, the angle of the fibers was approximately) 85°, over a thickness of 4 mm. The composite tape was composed of a Hyosung H2525 G10 carbon fiber which were impregnated with a resin of polyamide 11 type (reference Rilsan® FMNO) exhibiting a glass transition temperature of 50° C. (measured by DSC according to the standard ISO 11357-2:2013). The fiber content was 55% by volume (with respect to the volume of the composite tape). The composite tape was employed by means of an automatic deposition process with laser heating of Coriolis® Solo brand, at a temperature of 270° C. and a rate of 0.3 m/s.

The tube was closed with an M25 threaded plug at one of these ends and then pressurized at ambient temperature up to bursting. The bursting pressure measured was 1670 bar.

### Example 3

A composite tube, of circular section, exhibiting an external diameter of 170 mm and a thickness of 2 mm, is manufactured by pultrusion, at a rate of 0.5 m/min, by means of a melt impregnation process, using a tubular die connected to a single-screw extruder. The resin used for the pultrusion is a grade of polyamide 11 of low viscosity (reference Rilsan® FMNO) making it possible to obtain good impregnation of the fibers. This polyamide 11 resin exhibited an M.p. of 190° C. (measured according to the standard ISO 11357-3:2013) and the temperature in the pultrusion die was 250° C. The fibers used were 50K carbon fibers sold by SGL, of reference Sigrafil® C-T 50 4.8/280 T140. The fiber content was 45 vol % (fiber content with respect to the volume of the pultruded tube). The orientation of the fibers in the pultrusion die was exclusively along the axis of the tube.

The pultruded tube was cut into a segment with a length of 1.5 m. Each segment was cut at its ends, along the axis of the tube, into a strip with a length of 40 mm and these ends were heated to 150° C. and shaped to cover two caps, with a length of 20 mm, placed at each of the 2 ends of the tube. These caps consisted of an aluminum cylinder with a diameter of 80 mm, drilled with an M25 threaded hole, making possible linking with the standard connectors used in hydrogen.

An additional fibrous reinforcement, consisting of a composite tape with a width of ½″, was wound around the tube, perpendicular to its axis (given the width of the tape and the diameter of the pultruded tube, the angle of the fibers was approximately) 85° and over a thickness of 6 mm. This tape was also wound (with the same winding angle for the fibers) around the ends of the tube, shaped over the metal caps, so as to carry out crimping of the caps. The composite tape was composed of a Hyosung H2525 G10 carbon fiber which were impregnated with a resin of PA 11/BACT/10T type exhibiting a glass transition temperature of 140° C. (measured by DSC according to the standard ISO 11357-2:2013). The fiber content was 55% by volume (with respect to the volume of the composite tape). The composite tape was employed by means of an automatic deposition process with laser heating of Coriolis® Solo brand, at a temperature of 330° C. and a rate of 0.3 m/s.

Two tubes of the same type were manufactured and connected together by means of a connector with a diameter of 30 mm equipped with an M25 threaded cap and one of the tubes was closed at one of its ends by an M25 threaded plug. The tank thus formed exhibited a volume of 60 I and was pressure tested at a temperature of 23° C.: the bursting pressure measured was 1750 bar.

1. A tank for containing a pressurized fluid, comprising:
at least one cylindrical element made of a pultruded fibrous material impregnated with a thermoplastic matrix,
a first cap placed at one end of at least one cylindrical element closing it and
a second cap placed at the other end of at least one cylindrical element, fitted with an orifice intended to make possible the entry and the exit of the fluid, and
at least one additional fibrous reinforcement, partially or completely surrounding the cylindrical element(s) and optionally the caps,
the fibers contained in the additional fibrous reinforcement being positioned along a different axis from the longitudinal axis of the cylindrical element,
the total content of fibers of the tank being of between 40% and 70% by volume, with respect to the volumes of the matrix and of the fibers contained in the tank.

2. The tank as claimed in claim 1, wherein the additional fibrous reinforcement is chosen from dry continuous fibers, a fibrous material based on continuous fibers impregnated with a thermoplastic matrix, and their mixture.

3. The tank as claimed in claim 1 wherein the additional fibrous reinforcement comprises fibers positioned at an angle of between +/−10° and +/−89° with respect to the axis of the cylindrical element.

4. The tank as claimed in claim 1, wherein a portion of the fibers included in the material of the cylindrical element is positioned in the longitudinal axis of the cylindrical element.

5. The tank as claimed in and claim 1, wherein the additional fibrous reinforcement is chosen from a braid of dry continuous fibers, a braid of fibrous tapes impregnated with thermoplastic resin, and their mixture.

6. The tank as claimed in claim 1, wherein the fibers used to manufacture the pultruded fibrous material of the cylindrical element are a braid of dry fibers.

7. The tank as claimed in claim 2, wherein the additional fibrous reinforcement is a layer partially or completely surrounding the cylindrical element, which has been flattened beforehand over the caps, the layer being made of a fibrous material impregnated with thermoplastic resin.

8. The tank as claimed in claim 2, wherein the thermoplastic matrix of the cylindrical element is completely or partially miscible with the thermoplastic matrix of the additional fibrous reinforcement.

9. The tank as claimed in claim 2, wherein the thermoplastic matrix of the additional fibrous reinforcement exhibits a melting point of greater than 150° C. and/or a glass transition temperature of greater than 80° C.

10. The tank as claimed in claim 1, wherein the thermoplastic matrix of the cylindrical element predominantly contains a thermoplastic polymer or a blend of thermoplastic polymers.

11. The tank as claimed in claim 10, wherein the thermoplastic polymer is chosen from poly(aryl ether ketone) s (PAEKs); poly(aryl ether ketone ketone) s (PAEKKs); aromatic polyetherimides (PEIs); polyaryl sulfones; polyaryl sulfides; polyamides (PAs); PEBAs, the M.p. of which is greater than 150° C.; polyacrylates; polyolefins, with the exclusion of polypropylene; polylactic acid (PLA); polyvinyl alcohol (PVA); fluoropolymers; polyvinyl chloride (PVC); and acrylonitrile-butadiene-styrene (ABS) polymer and their blends.

12. The tank as claimed in claim 10, wherein the thermoplastic polymer is chosen from polyamides, aliphatic polyamides, cycloaliphatic polyamides and semiaromatic polyamides (polyphthalamides), PEKK, PEI, and a blend of PEKK and of PEI.

13. The tank as claimed in claim 10, wherein the thermoplastic polymer is chosen from aliphatic polyamides, cycloaliphatic polyamides, and semiaromatic polyamides (polyphthalamides).

14. The tank as claimed in claim 10, wherein the thermoplastic polymer is chosen from polyamide 6 (PA6), polyamide 11 (PA11), polyamide 12 (PA12), polyamide 66 (PA66), polyamide 46 (PA46), polyamide 610 (PA610), polyamide 612 (PA612), polyamide 1010 (PA1010), polyamide 1012 (PA1012), polyamide 11/1010 (PA11/1010) and polyamide 12/1010 (PA12/1010), or a blend of these or a copolyamide of these.

15. The tank as claimed in claim 10, wherein the thermoplastic polymer is chosen from a semiaromatic polyamide of formula A/XT in which:
A is chosen from a unit obtained from an amino acid, a unit obtained from a lactam and a unit corresponding to the formula (Ca diamine). (Cb diacid), with a representing the number of carbon atoms of the diamine and b representing the number of carbon atoms of the diacid, a and b each being of between 4 and 36, the (Ca diamine) unit being chosen from linear or branched aliphatic diamines, cycloaliphatic diamines and alkylaromatic diamines and the (Cb diacid) unit being chosen from linear or branched aliphatic diacids, cycloaliphatic diacids and aromatic diacids;
XT denotes a unit obtained from the polycondensation of a Cx diamine and of terephthalic acid, with x representing the number of carbon atoms of the Cx diamine, x being of between 6 and 36.

16. The tank as claimed in claim 15, wherein the thermoplastic polymer is chosen from a semiaromatic polyamide of formula A/6T, A/9T, A/10T or A/11T; T corresponds to terephthalic acid.

17. The tank as claimed in claim 1, wherein the fibrous material is chosen from glass fibers, carbon fibers, basalt fibers, and basalt-based fibers.

18. The tank as claimed in claim 1, wherein it comprises several cylindrical elements connected to one another and exhibiting an internal diameter of less than 250 mm.

19. The tank as claimed in claim 1, wherein it comprises, inside the cylindrical element, a second cylindrical element composed of one or more layers of thermoplastic resin, not comprising fibers.

20. The tank as claimed in claim 1, wherein the tank contains a liner.

21. A process for the manufacture of the tank as defined in claim 1, the method comprising the following successive stages:
(a) pultrusion of the cylindrical element,
(b) placement of the caps at the ends of the cylindrical element obtained on conclusion of stage (a),
(c) deposition of the additional fibrous reinforcement.

22. The process as claimed in claim 21, wherein the stage of deposition of the additional fibrous reinforcement is carried out by winding the tape of additional fibrous reinforcement around the cylindrical element and its caps.

23. The process as claimed in claim 22, wherein said deposition is carried out under a certain mechanical stress so as to exert pressure on the caps and the cylindrical element.

24. A method of using the tank as defined in claim 1 for the storage, the transportation and/or the distribution of fluids in the compressed form, in the liquid form or also in the cryocompressed form.
